(19) United States
(12) Patent Application Publication
(10) Pub. No.: US 2024/0202573 A1
(43) Pub. Date: Jun. 20, 2024

(54) GENERATION OF DATA TRANSFORMATIONS USING FINGERPRINTS

(71) Applicant: INTERNATIONAL BUSINESS MACHINES CORPORATION, ARMONK, NY (US)

(72) Inventors: Nagarjuna Surabathina, Prakasam(dt) (IN); Nitin Gupta, Saharanpur (IN); Shramona Chakraborty, Howrah (IN); Hima Patel, Bengaluru (IN); Sameep Mehta, Bangalore (IN); Ramkumar Ramalingam, Theni (IN); Matu Agarwal, Bangalore (IN)

(21) Appl. No.: 18/067,871

(22) Filed: Dec. 19, 2022

(51) Int. Cl. G06N 20/00; G06N 3/004

(52) U.S. Cl. CPC G06N 20/00; G06N 3/004

(57) ABSTRACT

A method, computer program product, and computer system for transforming sets of source data having different formats into respective sets of target data having a same format. N source patterns are determined and respectively describe N different formats in which N sets of source data items are formatted, where N≥1. A target format pattern is determined and describes a target format in which a target data items are formatted. N graphs are generated and respectively describe transformations of the N source patterns to the target pattern. Each graph includes multiple transformation paths. Each transformation path transforms the source pattern to the target pattern in a manner that maps source strings in the source pattern to each target string in the target pattern. A single transformation path is selected from the multiple transformation paths resulting in N single transformation paths having been selected.

### BACKGROUND

The present invention relates in general to generating and recommending a one-to-one mapping of samples from a source and target for transforming data in files, and in particular to transforming the format of data in files to conform to the format of the data in a target file

There is a need to improve uniformity of data format for multiple users who access the data.

### SUMMARY

Embodiments of the present invention provide a method, a computer program product and a computer system, for transforming one or more sets of source data having different formats into respective sets of target data having a same format.

One or more processors of a computer system determine N source patterns respectively describing N different formats in which N sets of source data items are formatted. Each source pattern comprises an ordered sequence of source strings. N≥1. If N≥2 then the N different formats are mutually compatible.

The one or more processors determine a target format pattern describing a target format in which a plurality of target data items is formatted. The target format differs from and is mutually compatible with each different format of the N different formats of the N source patterns. The target format pattern comprises an ordered sequence of target strings.

The one or more processors generate N graphs respectively describing transformations of the N source patterns to the target pattern. Each graph comprises a plurality of transformation paths, resulting in N pluralities of transformation paths having been generated. The N pluralities of transformation paths respectively correspond to the N source patterns. Each transformation path of each graph transforms the source pattern to the target pattern in a manner that maps one or more portions of source strings in the source pattern to each target string of one or more target strings in the target pattern.

The one or more processors select, from each plurality of transformation paths, a single transformation path, resulting in N single transformation paths having been selected.

### BRIEF DESCRIPTION OF THE DRAWINGS

FIG. 1 is a flow chart describing a method for transforming one or more sets of source data having different formats into respective sets of target data having a same format, in accordance with embodiments of the present invention.

FIG. 2 is an exemplary graph, in accordance with embodiments of the present invention.

FIG. 3 is a flow chart describing a process that selects a transformation path from a plurality of transformation paths in a graph, in accordance with embodiments of the present invention.

FIG. 4 is a flow chart describing a process for ranking multiple transformation paths, in accordance with embodiments of the present invention.

FIG. 5 depicts an exemplary hierarchy of levels of abstraction of the target format pattern, in accordance with embodiments of the present invention.

FIGS. 6 and 7 describe different types of mappings and exemplary Regexes that may be used for each type of mapping.

FIG. 8 illustrates a computer system, in accordance with embodiments of the present invention.

FIG. 9 depicts a computing environment containing an example of an environment for the execution of at least some of the computer code involved in performing the inventive methods in accordance with embodiments of the present invention.

### DETAILED DESCRIPTION

Data transformations are important from a data quality perspective.

Most standard feature extraction modules/classifiers can be impacted by heterogeneity in data.

In data transformations, source data in columns is translated into target data in columns, wherein heterogeneous source data having diverse formats is converted into homogeneous target data having a user intended format.

The source data and corresponding target data are all in a given class. Examples of different classes include currency, telephone numbers, surname, shipping codes, and names, as illustrated in Table 1, Table 2, Table 3, Table 4 and Table 5, respectively.

TABLE 1
Currency

| Source | Target |
|---|---|
| Rs. 9723409119 | 9723409119 |
| Rs. 2235313002 | 2235313002 |
| Rs. 870416581 | 870416581 |
| Rs. 3409245079 | 3409245079 |

TABLE 2
Telephone Numbers

| Source | Target |
|---|---|
| (+91) 3047733746 | 3047733746 |
| (+91) 9807928797 | 9807928797 |
| (+91) 9582117298 | 9582117298 |
| (+91) 2880922957 | 2880922957 |

TABLE 3
Surnames

| Source | Target |
|---|---|
| r. henneberry | henneberry |
| j. tran | tran |
| n. white | white |
| p. steiner | steiner |

A user may be unable to provide enough data transformation examples manually to generalize an algorithm to facilitate development of generalized data transformation program code.

Moreover, a single sample data transformation examples is usually not sufficient to facilitate development of generalized data transformation program code.

In other words, it is difficult to generate the data transformation program code manually because to do so requires an understanding of underlying data characteristics of the source data to be transformed.

For example, consider the following source data and target data in Table 4.

TABLE 4
Shipping Code

| Source | Target |
|---|---|
| 1Z TFX 926 49 0896 388 9 | 9 |
| 1Z NIY 49T 07 3957 129 7 | 7 |

The two data samples in Table 4 are not sufficient to facilitate development of generalized data transformation program code, because 9 and 7 in the Target column can be extracted from 12th position or from the last position of the string in the Source column.

In another example, consider the following source data and target data in Table 5.

TABLE 5
Names

| Source | Target |
|---|---|
| brad traficanti | traficanti |
| anna pagnanella | pagnanella |
| Paul Henkin | Henkin |

Table 5 includes three Source data inputs. However, development of generalized data transformation program code is not feasible, because strings such as Catherine Navarra should return “Navarra” but will incorrectly return “rine Navarra” based on the example of Table 5.

Thus, the user must provide sufficiently diverse multiple data transformation examples to understand underlying data characteristics of the source data to be transformed.

The present invention resolves the preceding problems.

The present invention provides automatic generation of one-to-one mappings for generation of program code to map fields between source and target fields.

The present invention provides generation of one-to-one mappings of samples from a source and target for transforming data in files.

The present invention provides fetching of data from source and target, where one-to-one mapping is absent, to generate multiple fingerprints that describe the format of the source data and target data.

In one embodiment, the fingerprints are each a regular expression (Regex). For the present invention, a regular expression is a sequence of text characters that specify a pattern describing one or more data formats.

In one embodiment, multiple fingerprints are analyzed to generate respective multiple samples of transformed source data. In one embodiment, the generated samples may be ranked to assist in selection of a single fingerprint to be used for subsequently transforming source data.

In one embodiment, fingerprints are generated based on both source and target data.

In one embodiment, mappings are found between the generated fingerprints

In one embodiment, mappings are used to generate recommended samples of transformed source data.

In one embodiment, target portions of target patterns are used to rank the generated samples.

In one embodiment, mappings for multiple patterns for multiple program generation are generated.

In one embodiment, user selected recommendations of fingerprint patterns are used to improve utilization of the transformed source data via uniformity of the format of the transformed source data.

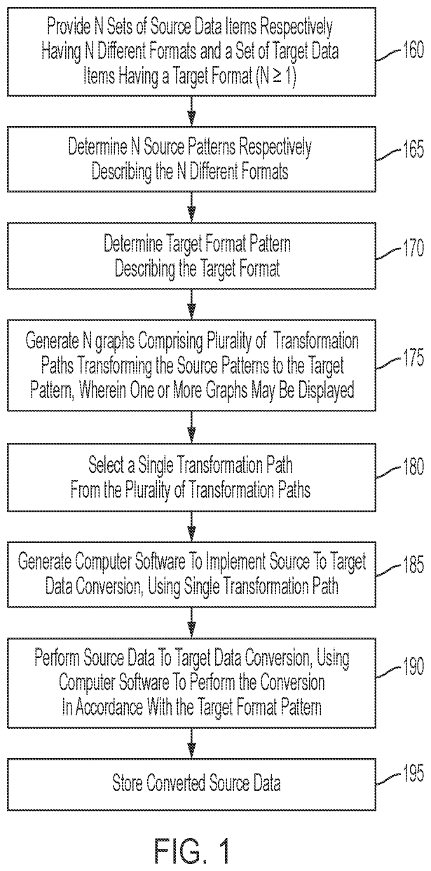

FIG. 1 is a flow chart describing a method for transforming one or more sets of source data having different formats into respective sets of target data having a same format, in accordance with embodiments of the present invention. The method of FIG. 1 includes steps 160-195.

Step 160 provides N sets of source data items respectively having N different formats and a set of target data items having a target format, wherein N≥ 1. The target format differs from any of the N different formats of the N sets of source data items. In one embodiment, N=1. In another embodiment, N≥ 2.

Tables 1-5 illustrate N=1 in which there is one set of source data items.

Table 6 illustrates N=2 in which there are two sets of source data items, each set containing 3 data items. Specifically, there are two sets of source items in Table 6, each set being specific to the class of Dates, namely sets Source1 and Source2.

TABLE 6
Dates

| Source1 | Source2 | Target |
|---|---|---|
| 02-05-2021 | 10.10.80 | 09/01/1921 |
| 09-03-2021 | 21.09.70 | 02/11/2022 |
| 19-11-2021 | 08.01.90 | 08/07/1921 |

The set of source data items in the source data of Source 1 is: 02-05-2021, 09-03-2021, and 19-11-2021.

The set of source data items in the source data of Source 2 is: 10.10.80, 21.09.70, and 08.01.90.

The set of target data items in the target data of Target 1 is: 09/01/1921, 02/11/2022, and 08/07/1921.

Source1 and Source2 have dates in a different format, and Target has dates in a target format differing from any of the formats of Source1 and Source 2.

The N different formats of the N sets of source data items and the target format of the target data items are mutually compatible, meaning by definition herein that the data in each of the N sets of source data items and the data in the set of target data items are in a same class. Thus, in Table 6, the 2 different formats corresponding to the 2 different sets of source items (Source1, Source2) and the target format corresponding to target data items are mutually compatible. Because the data items in SOURCE1, Source2, and Target are in the same class od Dates.

Step 165 determines N source patterns respectively describing the N different formats of the N sets of source data items.

Step 170 determines a target pattern describing the target format of the set of target data items.

In one embodiment, each source pattern of the N source patterns is a fingerprint of the respective format of the N different formats of the N sets of source data items, respectively, and the target pattern is a fingerprint of the target format of the set of target data.

In one embodiment, each source pattern of the N different formats of the N sets of source data items is expressed and represented by a regular expression (Regex), and the target pattern of the target format of the set of target data is likewise expressed and represented as a regular expression (Regex). The Regex of each source pattern comprises one or more source character strings. The Regex of the target pattern comprises one or more target character strings.

A regular expression (Regex) is well known as a text pattern, represented as a string of characters, describing a combination text characters, and may be used to match or represent character combinations. Thus, a Regex may be used to accept certain character strings and to reject other character strings. Examples presented herein for the present invention conformsto the well-known language in which regular expressions are expressed. The examples of source patterns and target patterns included herein are regular expressions.

A source pattern for the format of the source data items in Source1 in Table 6 may be the Regex of: [d]{2}-[d]{2}-[d]{4}.

A source pattern for the format of the source data items in Source2 in Table 6 may be the Regex of: [d]{2}.[d]{2}.[d]{2}.

A target pattern for the format of the source data items in Source2 in Table 6 may be the Regex of: [d]{2}/[d]{2}/[d]{4}.

Step 175 generates N graphs respectively describing transformations of the N source patterns to the target pattern. Each graph comprises nodes and one or more edges connecting successive nodes. Each graph depicts multiple mappings of a source pattern to a target pattern. Each mapping of a source pattern to a target pattern is represented in each graph as a transformation path through the nodes of the graph. The phrase “transformation path” and the word “mapping” have a same meaning herein and are used interchangeably herein.

Each graph generated in step 175 is a data structure that is stored in hardware storage of the computer system. After being generated, each graph may be displayed on a display device of the computer system.

Each graph comprises a plurality of transformation paths, resulting in N pluralities of transformation paths having been generated for the graphs. The N pluralities of transformation paths respectively correspond to the N source patterns respectively. Each transformation path of each graph transforms the source pattern to the target pattern in a manner that maps one or more portions of source strings in the source pattern to each target string of one or more target strings in the target pattern.

Table 7 depicts an illustrative set of source data items and an illustrative set of target data items.

TABLE 7
Dates

| Source | Target |
|---|---|
| 03-08-2023 | 07/05/1921 |
| 09-07-2021 | 06/10/2023 |
| 29-10-2022 | 11/04/1922 |

In one embodiment, the source pattern of Source in Table 7 is: [d]{2}-[d]{2}-[d]{4}, which may be parsed into source strings S0, S1, S2, S3 and S4 as follows:

S0=[d]{2}, S1=“-”, S2=[d]{2}, S3=“-”, S4=[d]{4}

In other words, S0 represents the first appearance of [d]{2} in the source pattern, S1 represents the first appearance of “-” in the source pattern, S2 represents the second appearance of [d]{2} in the source pattern, S3 represents the second appearance of “-” in the source pattern, and S4 represents [d]{4} in the source pattern.

In one embodiment, the target pattern of Target in Table 7 is: [d]{2}/[d]{2}/[d]{4}, which may be parsed into target strings T0, T1, T2, T3 and T4 as follows:

T0=[d]{2}, T1=“/”, T2=[d]{2}, T3=““/””, T4=[d]{4}

In other words, T0 represents the first appearance of [d]{2} in the target pattern, T1 represents the first appearance of “/” in the target pattern, T2 represents the second appearance of [d]{2} in the target pattern, T3 represents the second appearance of “/” in the target pattern, and T4 represents [d]{4} in the target pattern.

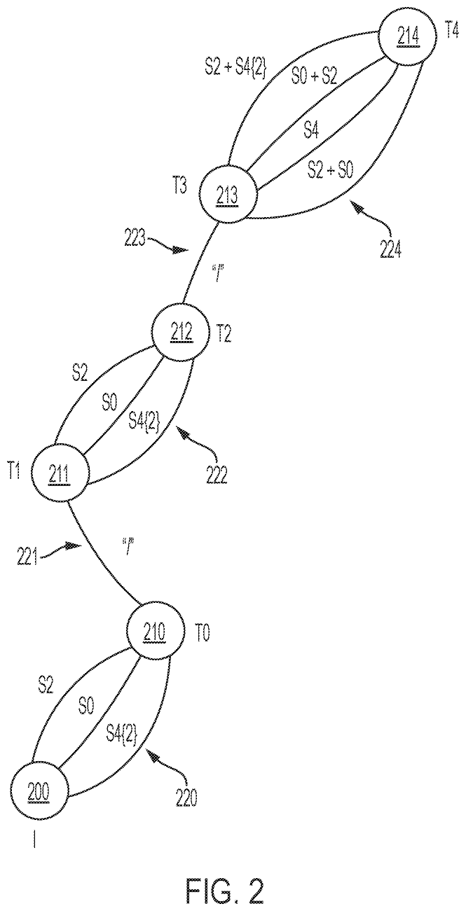

FIG. 2 is an exemplary graph, in accordance with embodiments of the present invention. The graph in FIG. 2 depicts multiple mappings of Source to Target in Table 7 and is expressed in terms of the preceding source strings (S0, S1, S2, S3, S4) and target strings (T0, T1, T2, T3, T4).

The graph in FIG. 2 includes an initial node 200 (denoted as I) and nodes 210, 211, 212, 213, and 214 respectively representing target strings T0, T1, T2, T3 and T4. The initial node I is a starting node representing a null string of “ ”.

The graph in FIG. 2 includes:
one or more edges 220 between nodes 200 and 210 (representing I and T0),
one or more edges 221 between nodes 210 and 211 (representing T0 and T1),
one or more edges 222 between nodes 211 and 212 (representing T1 and T2),
one or more edges 223 between nodes 212 and 213 (representing T2 and T3), and
one or more edges 224 between nodes 213 and 214 (representing T3 and T4).

A source string entity is defined as an edge representing a portion of a source string or a combination of portions of two or more source strings, wherein a portion of a source string is either the entire source string or less than the entire source string. For example, a source string entity of a portion of source string S4 (representing [d]{4}) is either the entire source string S4 or less than the entire source string S4 such as S4{2}. As another example, a source string entity could be S2+S4{2}, wherein S2 is the entire source string S2 and S4{2} is less the entire source string S4.

The one or more edges 220 include three source string entities: S2, S0 and S4 {2}.

The one or more edges 221 is the target string constant “/”.

The one or more edges 222 include three source string entities: S2, S0 and S4{2}.

The one or more edges 223 is the target string constant “/”.

The one or more edges 224 include four source string entities: S2+S4(2), S0+S2, S4, and S2+S0.

The graph in FIG. 2 includes a plurality of transformation paths. Each transformation path transforms the source pattern Source to the target pattern Target (see Table 7). Each transformation path begins at node 200 (I) and successively passes through nodes 210, 211, 212, 213, and 214 (representing the target string T0, T1, T2, T3, and T4), and passes through one edge between each pair of successive nodes.

The number of transformation paths in the graph in FIG. 2 is 36, calculated as the product of 3 (from edges 220), 3 (from edges 222) and 4 from edges 224).

Table 8 lists transformation paths in the graph in FIG. 2.

TABLE 8
Transformation Paths in FIG. 2.

| Transformation Path ID | Transformation Path |
|---|---|
| 1 | S0/S2/S4 |
| 2 | S2/S0/S4 |
| 3 | S0/S0/S4 |
| 4 | S0/S4{2}/S4 |
| 5 | S0/S2/S0 + S2 |
| 6 | S0/S0/S0 + S2 |
| 7 | S0/S4{2}/S0 + S2 |
| 8 | S2/S2/S4 |
| 9 | S2/S2/S0 + S2 |
| 10 | S4{2}/S0/S4 |
| . | . |
| . | . |
| . | . |
| 36 | S4{2}/S4{2}/S2 + S4{2} |

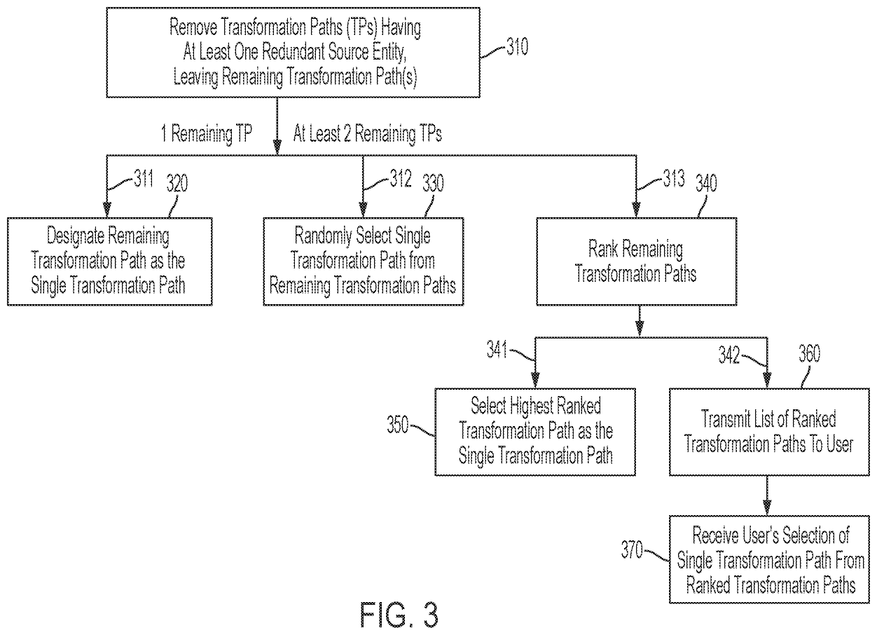

Step 180, which selects a single transformation path from the plurality of transformation paths in each graph, is described in FIG. 3.

FIG. 3 is a flow chart describing a process that selects a single transformation path from a plurality of transformation paths in a graph, in accordance with embodiments of the present invention. The flow chart of FIG. 3 includes steps 310-370.

Each transformation path in the graph represents a Source to Target mapping of the source data items in the Source with respect to the format of the source data items.

Step 310 removes, from the plurality of transformation paths in the graph, the transformation paths having at least one redundant source string entity, which changes the plurality of transformation paths to a remaining one or more transformation paths.

If no transformation path has any redundant source entity, then no transformation path will be removed in step 310 and the remaining one or more transformation paths will consist of the plurality of transformation paths in the graph.

A redundant source string entity in a transformation path is defined as a source string entity that appears more than once in the transformation path, which includes overlapping appearances of portions of the source string entity.

For example, S0 is a redundant source string entity in transformation path 3 in Table 8, because the source string entity S0 appears twice in transformation path 3.

As another example, S4 is a redundant source string entity in transformation path 4 in Table 8, because the source string entity S4 has overlapping appearances as S4 and a portion S4{2} of S4.

As another example, S4 is a redundant source string entity in transformation path 36 in Table 8, because the source string entity S4 has overlapping appearances of a portion S4{2} of S4.

An analysis of the 36 transformation paths in Table 8 results in removal of 34 transformation paths that have at least one redundant source string entity, leaving two remaining transformation paths 1 and 2 (i.e., transformation paths S0/S2/S0+S2 and S2/S0/S0+S2).

In general, the remaining transformation path(s) may consist of either one remaining transformation path or at least 2 remaining transformation paths.

If the remaining transformation paths from step 310 consists of one remaining transformation path, then the process of FIG. 3 proceeds to step 320 via branch 311.

Step 320 designates the one remaining transformation path as the single transformation path.

If the remaining transformation paths from step 310 consists of at least two remaining transformation paths, then the process of FIG. 3 proceeds to either step 330 via branch 312 or step 340 via branch 313. Steps 330 and 340 are alternative embodiments for implementing the process of FIG. 3 for the condition of at least two remaining transformation paths.

Step 330 randomly selects the single transformation path from the at least two remaining transformation paths.

Step 340 ranks the at least two remaining transformation paths.

After step 340 is performed the process branches to either step 350 via branch 341 or step 360 via branch 342, which are alternative embodiments for implementing the process of FIG. 3 after step 340 is performed.

Step 350 selects the highest ranked transformation path as the single transformation path.

Step 360 transmits a list of the ranked transformation paths to the user.

After step 360 is performed, step 370 receives the user's selection of a single transformation path from the ranked at least two transformation paths.

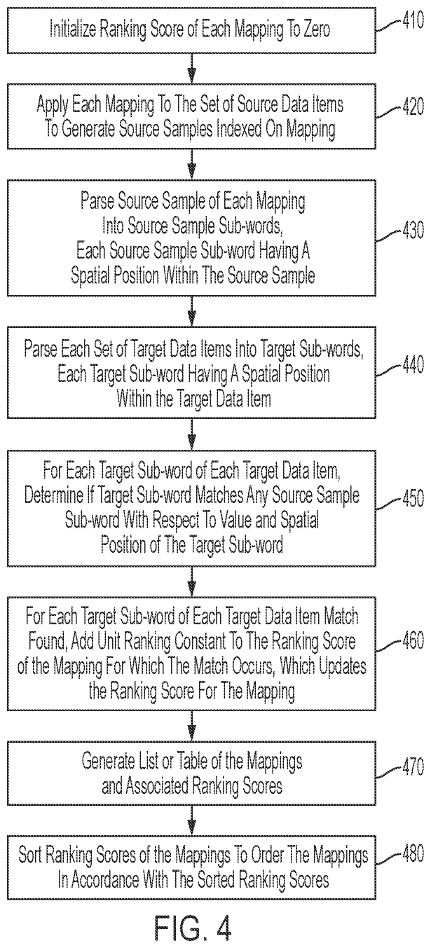

FIG. 4 is a flow chart describing a process for ranking multiple transformation paths, in accordance with embodiments of the present invention. The process of FIG. includes steps 410-470.

The process of FIG. 4 is an embodiment of step 340 in FIG. 3 and pertains to multiple transformation paths in one graph such as the graph in FIG. 2. The multiple transformation paths being ranked are at least two remaining transformation paths resulting from step 310 in FIG. 3. The embodiment of only one remaining transformation path is not relevant for the process of FIG. 4.

Each mapping of a source pattern to a target pattern is represented in each graph as a transformation path through the nodes of the graph. Thus, the phrase “transformation path” and the word “mapping” have a same meaning herein and are used interchangeably herein.

The description of the process of FIG. 4 uses “mapping” instead of “transformation path”.

The description of the process of FIG. 4 utilizes an example for illustrative purposes.

Input for the process of FIG. 4 includes a set of source data items and a set of target data items.

Illustratively, consider the following example in Table 9 which shows three source data items in a set of source data items and three target data items in a set of target data items.

TABLE 9
Set of Source Data Items and Set of Target Data Items

| Data Item No. | Source Data Item | Target Data Item |
|---|---|---|
| 1 | David Saul Frankel | Frankel Saul Ryan |
| 2 | Nancy Sarah Neaton | Neaton Sarah Russo |
| 3 | George Marvin Nagle | Thomas Saul Russo |

The ranking process is in accordance with a ranking score determined for each mapping.

Step 410 initializes a ranking score of each mapping to zero.

Step 420 applies each mapping to the set of source data items to generate source samples indexed on mapping, which is shown in Table 10 for the Example in Table 9.

TABLE 10
Source Samples

| Mapping | |
|---|---|
| Number | Source Sample |
| 1 | ‘David Frankel Saul’, ‘Nancy Neaton Sarah’, |
| | ‘George Nagle Marvin’ |
| 2 | ‘Saul David Frankel’, ‘Sarah Nancy Neaton’, |
| | ‘Marvin George Nagle’ |
| 3 | ‘Saul Frankel David’, ‘Sarah Neaton Nancy’, |
| | ‘Marvin Nagle George’ |
| 4 | ‘Frankel David Saul’, ‘Neaton Nancy Sarah’, |
| | ‘Nagle George Marvin’ |
| 5 | ‘Frankel Saul David’, ‘Neaton Sarah Nancy’, |
| | ‘Nagle Marvin George’ |

In Table 10, there are 5 mappings. Each mapping converts the set of source data in Table 9 into the source samples shown in FIG. 10 based on the set of target data shown in Table 9.

Step 430 parses each source data item of the source sample of each mapping into sample sub-words, wherein each source sample sub word has a spatial position within the data item.

For example, the first source data item of ‘David Frankel Saul’ in Mapping 1 in Table 10 is parsed into the 3 sub-words of David, Frankel, and Saul having spatial positions 1, 2. and 3, respectively, within the first source data item of the source sample resulting from Mapping 1.

As another example, the second source data item of ‘Sarah Seaton Nancy’ in Mapping 3 in Table 10 is parsed into the 3 sub-words of Sarah, Seaton, and N having spatial positions 1, 2. and 3, respectively, within the second source data item of the source sample resulting from Mapping 3.

Step 440 parses each target data item of the target sample into target sub-words, wherein each target sub-word has a spatial position within the target data item.

For example, the first target data item of ‘Frankel Saul Ryan’ in Table 9 is parsed into the 3 sub-words of Frankel, Saul, and Ryan having spatial positions 1, 2. and 3, respectively, within the first target data item.

As another example, the second target data item of ‘Neaton Sarah Russo’ in Table 9 is parsed into the 3 sub-words of Neaton, Sarah, and Russo having spatial positions 1, 2, and 3, respectively, within the second target data item.

Step 450 determines for each target sub word of each target data item, if the target sub-word matches any source sample sub word with respect to value and spatial position of the target sub-word.

For each target sub-word of each target data item match found in step 450, step 460 adds a unit ranking constant to the ranking score of the mapping for which the match occurs, which updates the ranking score for the mapping. The unit ranking score is a positive constant such as, inter alia, +1.

For example, the target sub-word Frankel in spatial position 1 of target data item 1 of ‘Frankel Saul Ryan’ in Table 9 is matched by the source sample sub-word Frankel in position 1 of the first source sample data item in the source sample resulting from Mapping 4 in Table 10, as well as being matched by the source sample sub-word Frankel in the first source sample data item in the source sample resulting from Mapping 5 in Table 10. Thus, the unit ranking constant (e.g., +1) is added to the ranking score of Mapping 4 and also to the ranking score of Mapping 5.

As another example, the target sub-word Saul in spatial position 2 of target data item 3 of ‘Thomas Saul Russo’ in Table 9 is matched by the source sample sub-word Kumar in position 2 of the first source sample data item in the source sample resulting from Mapping 5 in Table 10. Thus, the unit ranking constant (e.g., +1) is added to the ranking score of Mapping 5.

As another example, the target sub-word Neaton in spatial position 1 of target data item 2 of ‘Neaton Sarah Russo’ in Table 9 is not matched by any source sample sub-word in position 1 of any source sample data item in any source sample resulting from any mapping in Table 10. Thus, the unit ranking constant (e.g., +1) is not added to the ranking score of any mapping.

Step 470 generates a list or table of the mappings and associated ranking scores determined in steps 450 and 460.

Step 480 sorts the ranking scores in the list or table generated in step 470, resulting in a table in which the mappings are ordered according to the result of the sort performed in step 480.

After steps 450 and 460 are performed for each target sub-word of each of the target data items (i.e., for the 9 target sub-words in Table 9), the ranking scores of the mappings are shown in Table 11 which results from performance of step 470.

Table 12 orders the mappings according to the sorting performed in step 480 and shows the rank of the mappings resulting from the sorting, wherein mappings 5 and 4 are the first and second highest mappings, respectively.

TABLE 11
Ranking Score of Mappings

| Mapping Number | Ranking Score |
|---|---|
| 1 | 0 |
| 2 | 0 |
| 3 | 0 |
| 4 | 2 |
| 5 | 4 |

TABLE 12
Rank of Mappings

| Mapping Number | Ranking Score | Rank |
|---|---|---|
| 5 | 4 | 1 |
| 4 | 2 | 2 |
| 1 | 0 | 3 |
| 2 | 0 | 3 |
| 3 | 0 | 3 |

Returning to FIG. 1, step 185 generates computer software (i.e., program code) configured to perform a source data to target data conversion upon being executed, in accordance with the target format pattern as described supra. The software is stored on one or more hardware storage devices after being generated.

Step 190 uses the computer software to perform the source data to target data conversion in accordance with the target format pattern.

In one embodiment, the computer software is available to perform step 190 and thus does not need to be generated, in which case step 185 need not be performed. For example, the computer software may be a stored computer program configured to generally convert source data to target data in accordance with the target format pattern.

In one embodiment, step 185 is performed to generate efficient computer software that exploits specific features of the single transformation path selected in step 180.

For example, many different computer programs may be configured as the computer software, so if the single transformation path does not include the Regex+operator, then computer code using a Regex to find character positions are not needed and those different computer programs having such computer code using such Regex to find character positions may be discarded or pruned from the many different computer programs.

In one embodiment, generation of the computer software in step 185 may be implemented using specially designed hardware components (e.g., a specialized integrated circuit, such as for example an Application Specific Integrated Circuit (ASIC)) designed only and specifically for generating the computer software, wherein specific features of transformation paths are built into the hardware of specially designed components (e.g., the hardware of the ASIC). In one embodiment, the hardware of the specially designed components, such the hardware of the ASIC, may be designed to decode, modify, manipulate specified types of regular expression for generating the computer software.

Step 195 stores the source data converted according to step 190 in hardware data storage of the computer system, which provides access to the converted source data by multiple users of the computer system regardless of the different formats in which the source data was formatted before being converted.

In a particular embodiment, step 190 converts n sets of source data items having respective n different formats of the N different formats into the target format, using respective n different single transformation paths of the N single transformation paths to perform the converting, wherein 2≤n≤N.

In the particular embodiment, step 195 stores, in the hardware data storage of the computer system, the converted n sets of source data items, which provides access to the converted n sets of source data items in the target format by multiple users of the computer system regardless of the n different formats in which the n sets of source data items were formatted before the converting is performed.

The target format pattern may be selected, by the user, from target format patterns determined in step 170 of FIG. 1 at different levels of abstraction. A higher level of abstraction means fewer number patterns but facilitates generation of a higher number of source samples. A lower level of abstraction but facilitates a higher chance of obtaining more than one pattern but generates a fewer number of source samples.

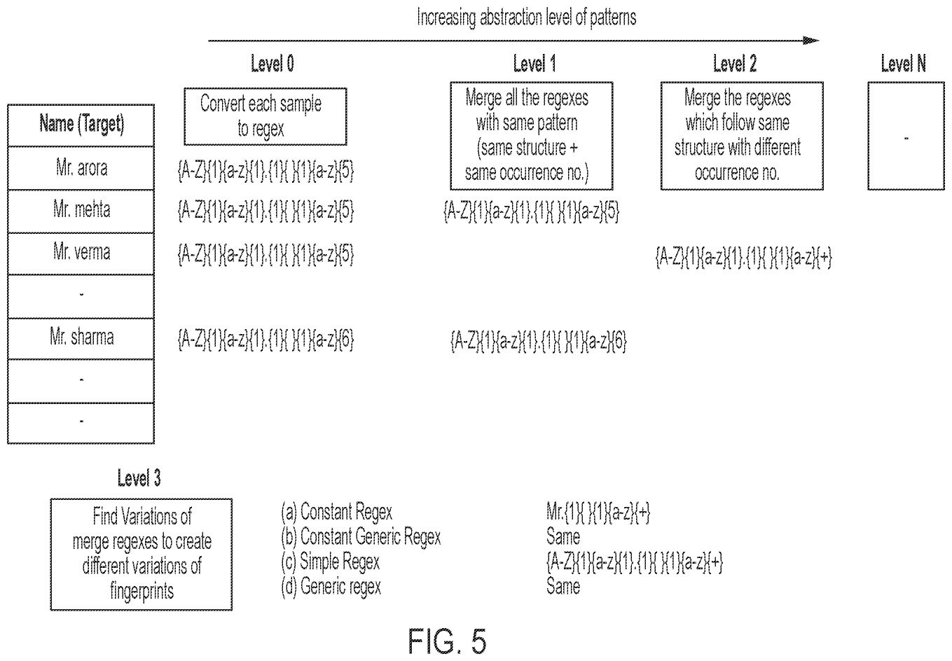

FIG. 5 depicts an exemplary hierarchy of levels of abstraction of the target format pattern, in accordance with embodiments of the present invention.

The levels of abstraction depicted in FIG. 5 are illustrated with specific examples of Regexes at different levels of abstraction. For example, the +Regex operator is used to transition from Level 1 to Level 2.

It is noted that Level 2 is a lowest level of abstraction for a pattern having a variable number of appearances of characters of a specified genre such as lower case characters, upper case characters, etc.

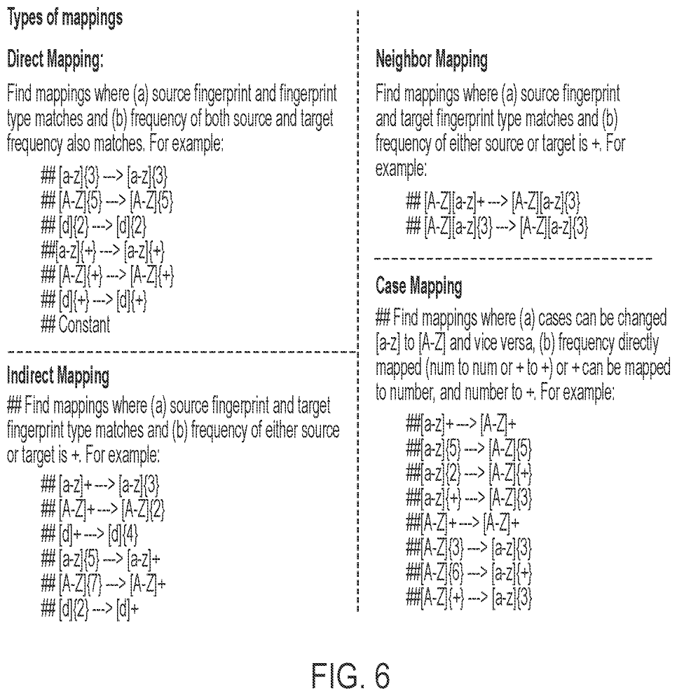

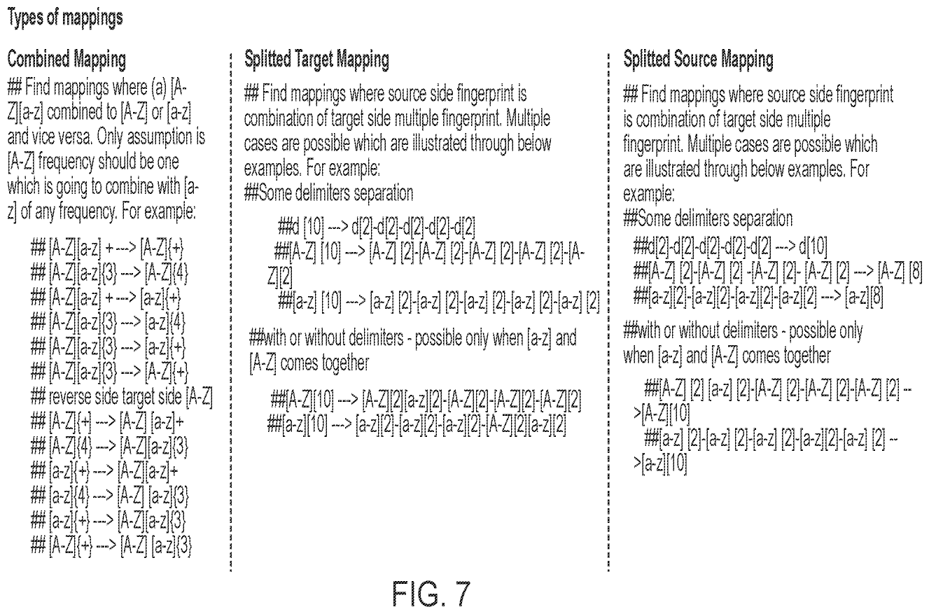

FIGS. 6 and 7 describe different types of mappings and exemplary Regexes that may be used for each type of mapping.

The described types of mappings in FIGS. 6 and 7 include direct mapping, indirect mapping, neighbor mapping, case mapping, combined mapping, split target mapping, and splitted source mapping.

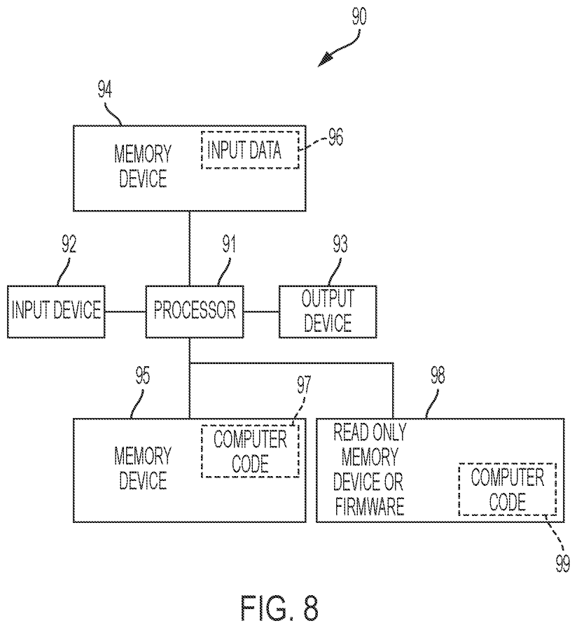

FIG. 8 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 98 (e.g., including algorithms) may be stored on a static, nonremovable, read-only storage medium such as a Read-Only Memory (ROM) device 99, or may be accessed by processor 91 directly from such a static, nonremovable, read-only medium 99. Similarly, in some embodiments, stored computer program code 97 may be stored as computer-readable firmware 99, or may be accessed by processor 91 directly from such firmware 99, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

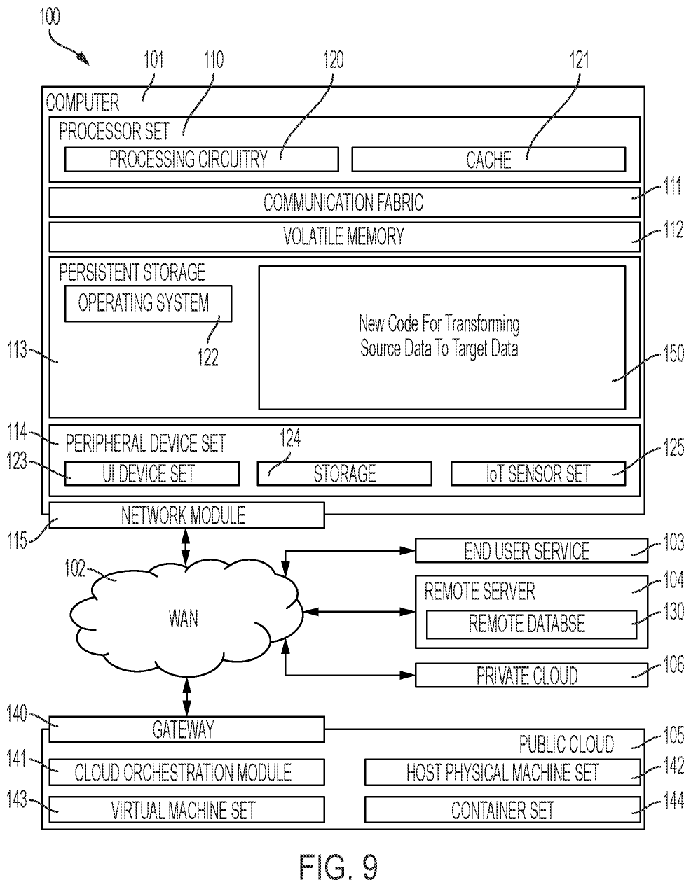

FIG. 9 depicts a computing environment 100 containing an example of an environment for the execution of at least some of the computer code involved in performing the inventive methods, such as new code for transforming source data to target data 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Examples and embodiments of the present invention described herein have been presented for illustrative purposes and should not be construed to be exhaustive. While embodiments of the present invention have been described herein for purposes of illustration, many modifications and changes will become apparent to those skilled in the art. The description of the present invention herein explains the principles underlying these examples and embodiments, in order to illustrate practical applications and technical improvements of the present invention over known technologies, computer systems, and/or products.

What is claimed is:

1. A method for transforming one or more sets of source data having different formats into respective sets of target data having a same format, said method comprising:
determining, by one or more processors of a computer system, N source patterns respectively describing N different formats in which N sets of source data items are formatted, wherein each source pattern comprises an ordered sequence of source strings, wherein N≥1, and wherein if N>1 then the N different formats are mutually compatible;
determining, by the processor, a target format pattern describing a target format in which a plurality of target data items is formatted, wherein the target format differs from and is mutually compatible with each different format of the N different formats of the N source patterns, wherein the target format pattern comprises an ordered sequence of target strings;
generating, by the one or more processors, N graphs respectively describing transformations of the N source patterns to the target pattern, wherein each graph comprises a plurality of transformation paths, resulting in N pluralities of transformation paths having been generated, wherein the N pluralities of transformation paths respectively correspond to the N source patterns, and wherein each transformation path of each graph transforms the source pattern to the target pattern in a manner that maps one or more portions of source strings in the source pattern to each target string of one or more target strings in the target pattern; and
selecting, by the one or more processors from each plurality of transformation paths, a single transformation path, resulting in N single transformation paths having been selected.

2. The method of claim 1, wherein the target pattern and each source format pattern are regular expressions.

3. The method of claim 1, wherein N=1.

4. The method of claim 1, wherein N≥2.

5. The method of claim 4, said method further comprising:
converting, by the processor using computer software, n sets of source data items having respective n different formats of the N different formats into the target format, using respective n different single transformation paths of the N single transformation paths to perform said converting, wherein 2≤n≥N; and
storing, by the processor in the hardware data storage of the computer system, the converted n sets of source data items, which provides access to the converted n sets of source data items in the target format by multiple users of the computer system regardless of the n different formats in which the n sets of source data items were formatted before said converting.

6. The method of claim 5, said method further comprising:
prior to said converting, generating the computer software by an Application Specific Integrated Circuit (ASIC)) designed only and specifically for generating the computer software, wherein specific features of transformation paths are built into the hardware of the ASIC.

7. The method of claim 1, wherein said selecting from each plurality of transformation paths comprises:
removing all transformation paths having at least one redundant source string entity, which changes the plurality of transformation paths to a remaining one or more transformation paths; and
selecting, by the one or more processors from the remaining one or more transformation paths, the single transformation path.

8. The method of claim 7, wherein the remaining one or more transformation paths comprises two or more transformation paths, and wherein said selecting from the two or more transformation paths comprises:
ranking the two or more transformation paths; and
selecting the highest ranked transformation path as the single transformation path.

9. The method of claim 7, wherein the remaining one or more transformation paths comprises two or more transformation paths, and wherein said selecting from the two or more transformation paths comprises:
ranking the two or more transformation paths;
transmitting the ranked two or more transformation paths to a user;
receiving, from the user, the user's selection of one transformation paths of the ranked two or more transformation paths as the single transformation path.

10. The method of claim 7, wherein the one or more transformation paths comprises two or more transformation paths, and wherein said selecting from the two or more transformation paths comprises:
randomly selecting a transformation path from the two or more transformation paths as the single transformation path.

11. A computer program product, comprising one or more computer readable hardware storage devices having computer readable program code stored therein, said program code containing instructions executable by one or more processors of a computer system to implement a method for transforming one or more sets of source data having different formats into respective sets of target data having a same format, said method comprising:
determining, by the one or more processors, N source patterns respectively describing N different formats in which N sets of source data items are formatted, wherein each source pattern comprises an ordered sequence of source strings, wherein N≥1, and wherein if N>1 then the N different formats are mutually compatible;
determining, by the processor, a target format pattern describing a target format in which a plurality of target data items is formatted, wherein the target format differs from and is mutually compatible with each different format of the N different formats of the N source patterns, wherein the target format pattern comprises an ordered sequence of target strings;
generating, by the one or more processors, N graphs respectively describing transformations of the N source patterns to the target pattern, wherein each graph comprises a plurality of transformation paths, resulting in N pluralities of transformation paths having been generated, wherein the N pluralities of transformation paths respectively correspond to the N source patterns, and wherein each transformation path of each graph transforms the source pattern to the target pattern in a manner that maps one or more portions of source strings in the source pattern to each target string of one or more target strings in the target pattern; and
selecting, by the one or more processors from each plurality of transformation paths, a single transformation path, resulting in N single transformation paths having been selected.

12. The method of claim 11, wherein the target pattern and each source format pattern are regular expressions.

13. The method of claim 11, wherein N=1.

14. The method of claim 11, wherein N≥2.

15. The method of claim 14, said method further comprising:
converting, by the processor using computer software, n sets of source data items having respective n different formats of the N different formats into the target format, using respective n different single transformation paths of the N single transformation paths to perform said converting, wherein 2≤ n & N; and
storing, by the processor in the hardware data storage of the computer system, the converted n sets of source data items, which provides access to the converted n sets of source data items in the target format by multiple users of the computer system regardless of the n different formats in which the n sets of source data items were formatted before said converting.

16. A computer system, comprising one or more processors, one or more memories, and one or more computer readable hardware storage devices, said one or more hardware storage devices containing program code executable by the one or more processors via the one or more memories to implement a method for transforming one or more sets of source data having different formats into respective sets of target data having a same format, said method comprising:
determining, by the one or more processors, N source patterns respectively describing N different formats in which N sets of source data items are formatted, wherein each source pattern comprises an ordered sequence of source strings, wherein N≥1, and wherein if N>1 then the N different formats are mutually compatible;
determining, by the processor, a target format pattern describing a target format in which a plurality of target data items is formatted, wherein the target format differs from and is mutually compatible with each different format of the N different formats of the N source patterns, wherein the target format pattern comprises an ordered sequence of target strings;
generating, by the one or more processors, N graphs respectively describing transformations of the N source patterns to the target pattern, wherein each graph comprises a plurality of transformation paths, resulting in N pluralities of transformation paths having been generated, wherein the N pluralities of transformation paths respectively correspond to the N source patterns, and wherein each transformation path of each graph transforms the source pattern to the target pattern in a manner that maps one or more portions of source strings in the source pattern to each target string of one or more target strings in the target pattern; and
selecting, by the one or more processors from each plurality of transformation paths, a single transformation path, resulting in N single transformation paths having been selected.

17. The method of claim 16, wherein the target pattern and each source format pattern are regular expressions.

18. The method of claim 16, wherein N=1.

19. The method of claim 16, wherein N≥2.

20. The method of claim 19, said method further comprising:
converting, by the processor using computer software, n sets of source data items having respective n different formats of the N different formats into the target format, using respective n different single transformation paths of the N single transformation paths to perform said converting, wherein 2≤ n≥N; and
storing, by the processor in the hardware data storage of the computer system, the converted n sets of source data items, which provides access to the converted n sets of source data items in the target format by multiple users of the computer system regardless of the n different formats in which the n sets of source data items were formatted before said converting.
